(19) United States
(12) Patent Application Publication
(10) Pub. No.: US 2024/0284949 A1
(43) Pub. Date: Aug. 29, 2024

(54) METHOD FOR PRODUCING A MOLDED POTATO PRODUCT, AND MOLDED POTATO PRODUCT

(71) Applicant: Matthias Schade, Gotha-Boilstädt (DE)

(72) Inventor: Matthias Schade, Gotha-Boilstädt (DE)

(21) Appl. No.: 18/294,517

(22) PCT Filed: Aug. 5, 2022
(86) PCT No.: PCT/DE2022/100567

§ 371 Date: Feb. 1, 2024

(30) Foreign Application Priority Data
Aug. 5, 2021 (DE) 10 2021 120 408.9

(51) Int. Cl. A23L 19/18; A23L 19/12

(52) U.S. Cl. CPC A23L 19/19; A23L 19/13

(57) ABSTRACT

The invention relates to a method for producing a molded potato product, comprising temperature control in two steps, and to a molded potato product produced by a method of said kind.

The invention relates to a method for producing a molded potato product, in particular a revivable molded potato product, and to a molded potato product produced using such a method.

The dumpling (plural: dumplings) or the knoedel (plural: knoedels) is a dish which is made from dough and eaten as a main course, side dish or soup garnish. Dumplings and knoedels actually refer to the same side dish (in southern Germany, the term “knoedel” is mainly used). Round shapes are called dumplings, other shapes are called knoedels.

Starch can physically bind water many times its own weight under the influence of heat, swell and gelatinize. When heated with water, the starch swells at 47-57° C., the layers burst, and at 55-87° C. (potato starch at 62.5° C., wheat starch at 67.5° C.) starch paste is formed, which has different stiffening properties depending on the type of starch (corn starch paste has a greater stiffness than wheat starch paste, the latter has a greater stiffness than potato starch paste). The result is a gelatinous mass.

At cool temperatures, this effect slowly disappears and the water is released again—this is known as retrogradation.

When preparing potato dumplings, the starchy dumpling dough mass is heated in a bain-marie for several minutes, depending on the size of the dumpling. In doing so, the dumpling absorbs water in an uncontrolled manner. If gelatinization has not yet started inside, the outer skin may have already swollen so much that the dumpling has an unpleasant gelatinous layer. If such a dumpling were to be preserved, the consistency of the dumpling would be lost due to the high water content during preservation, for example through cooling.

So far, gelatinized dumpling doughs cannot be revived, which means that dumplings that have already been cooked can only be reheated with considerable loss of quality.

In order to make domestic production easier, raw dumpling batches are therefore currently provided in which the starch is present in a non-gelatinized form. However, these cannot be permanently shaped due to the lack of structuring substances. In fact, shaping would not be permanent. However, this means that both the shaping of the dumpling and the entire cooking process have to be carried out in a time-consuming way by oneself.

The object of the invention is now to eliminate or at least reduce the problems of the prior art. In particular, a molded dumpling product is to be provided which is precooked and can be revived without loss of quality while retaining its shape.

In this context, “revivable” means that the molded potato product can be heated in such a way that a fluffy consistency and a taste are achieved in the end which are similar to a conventionally prepared dumpling.

This task is solved by a method and a molded dumpling product comprising the features of the independent claims.

Thus, a first aspect of the invention relates to a method for producing a molded potato product, comprising the following steps. First, a raw potato mass is provided, comprising all parts of raw, peeled and crushed potatoes and/or of a technically prepared equivalent. The comminution takes place in particular in such a way that potato fibers remain in the mass, preferably by grating or rasping.

Furthermore, a potato mass is provided which comprises cooked, peeled and crushed potatoes and/or a technically prepared equivalent thereof. Here, mashing or crushing is preferably selected as the comminution method. It is further advantageous if the cells are not destroyed so that the potato starch remains in the cells in order to prevent unwanted gelatinization. Pureeing, for example with a rotating cutting blade or stirring rod, is therefore less preferable.

The two masses are then blended to form a mixture. Optionally, other ingredients such as potato flour, spices, flour, eggs and/or milk can be added to the mixture.

Before the mass is shaped into a molded product, the mixture is cooled down to a predetermined temperature, in particular to a temperature in the range from 4 to 15° C. This enables the molded product to be shaped into a very precise form. Shaping is preferably carried out by means of pressing the mixture into a negative mold. When producing large quantities, industrially accessible shaping by means of a mold plate machine or drum molding machine is preferred.

According to the invention, the shaped mass is then thermally treated in order to gelatinize starch components in the mixture, the thermal treatment being carried out in such a way that a water content in the molded product does not increase before, after and/or during the thermal treatment, while it is particularly preferred that it decreases by up to 10%.

This ensures that a blank is produced which has a rubber-like consistency. The consistency is created by the gelatinization of the starch, which leads to bonding and network formation of adjacent particles. However, as no additional water could be absorbed by the mixture, the blank does not have a gel-like layer compared to conventional cooked dumplings. In addition, homogeneous gelatinization occurs over the entire cross-section.

This in turn results in that the shape of the molded product is almost identical to that of the blank. This opens up a wide range of new shapes for molded potato products, which differ in particular from those of a normal round dumpling, but also from the familiar duchess potatoes, croquettes and the like.

In addition, the homogeneous and almost complete gelatinization induces a reduction of digestible starch in the blank. It has been shown that the gelatinization according to the invention leads to an increased proportion of dietary fibers and a reduced proportion of digestible carbohydrates in the ready-to-eat end product.

Advantageously, the molded product according to the invention has an increased shelf life. It has been confirmed by experts that when the molded product is packaged without the exclusion of oxygen, no deep-freezing is necessary to ensure a shelf life of 3 and even 6 months. Rather, normal refrigeration is sufficient. The molded product according to the invention is thus preserved by the production method in such a way that no chemical or other preservation is required. Furthermore, no increased demands are imposed on transportation, such as the uninterrupted maintenance of a (deep-freeze) cold chain.

The thermal treatment is advantageously carried out by means of deep-frying or by means of a superheated steam method, in particular by means of a combi-steamer or spiral stove. Deep-frying has the particular advantage that a top layer in the form of a crust is formed on the outside of the molded product, which limits or prevents water loss from the mass of the molded product. Furthermore, as no water is added, the water content in the mass of the molded product remains constant or is slightly reduced. Depending on the weight and thickness of the molded product, deep-frying is preferably carried out at a temperature in the range from 160 to 185° C., in particular in the range from 170 to 180° C. and/or for a period of time in the range from 1.5 to 6 min, in particular 2.5 to 5 min.

A combi-steamer, spiral stove or convection steamer combines the functions of a steamer, in which foods to be cooked are cooked in a saturated steam atmosphere, and of a convection oven, in which cooking takes place with circulating air. As the temperature and humidity can be varied over a wide range with said appliances, they allow full control or regulation of the cooking climate over a wide range. In addition, due to the relatively high circulating air speed of the fan and the condensation of the steam on the food to be cooked, a comparatively short cooking time and therefore gentle preparation of the food can be achieved.

Due to the steam content when using a combi-steamer or spiral stove in the method according to the invention, a small amount of water is released from the mass of the molded product, approx. 2%. In order to avoid water absorption as far as possible, the cooking time is kept as short as possible and the water saturation is set between 60% and 80%. It was found that a steaming time in a temperature range from 115° to 145°, in particular from 120° to 140° for 75 to 100 s, in particular for 85 to 95 s with a molded product having a thickness of 1 cm causes sufficient gelatinization with a largely constant water content in the mass of the molded product.

The added water vapor prevents the gelatinized blank from drying out and hardening. Water loss with resulting solidification is achieved with this embodiment in the course of a subsequent cooling process (weight loss approx. 6%).

If the shaping is carried out using a shaping negative mold, the molded product can optionally remain in this negative mold during cooking in the combi-steamer. Preferably, however, the cooking times and/or temperatures are then adjusted, in particular increased, as the material of the negative mold has an influence on the cooking process due to its inherent heat conduction properties. For example, the use of a silicone mold as a negative mold requires a doubling of the cooking time in the combi-steamer at the same temperature.

Especially when using industrial equivalents, a proportion of uncooked potatoes in the mass can be dispensed with. This essentially provides the potato fibers that are required for the formation of net-like branched structures for stabilization.

Industrially produced equivalents are understood here to mean preserved extracts of potatoes, such as potato flour or starch flour, potato fibers or dried potato puree.

In a preferred configuration of the method according to the invention, it is provided that the potato raw mass has a proportion in the range from 10 to 75%, preferably in the range from 10 to 55%, in particular in the range from 20 to 50% of the mixture. In the case of fresh products, this is primarily dependent on the potato variety, as the starch and water content as well as the starch composition in particular vary depending on the variety. Naturally, this is more predictable with industrially produced equivalents.

It is particularly advantageous to preserve and temporarily store the blank, especially by refrigeration, deep-freezing, vacuum packaging and/or the like.

Before consumption, the blank must be revived. This is preferably carried out in a further method step in which the blank is revived by heat application, in particular by means of deep-frying, baking, toasting or in a hot water bath. Depending on the method chosen, a dumpling is obtained that has a tender outside and a fluffy consistency (combination of combi-steamer for blank production and water bath for revitalization) or one with a fine crust and fluffy consistency inside.

Depending on the method selected, the heat is preferably applied for a duration of 1.5 to 10 min during revitalization. In this context, the preferred deep-frying time is in the range from 1.5 to 5 min, in particular 2 to 3 min.

Advantageously, the molded product has a thickness in the range from 1 to 5 cm. It has been shown that optimized molded potato products are achieved in terms of homogeneity and cooking results especially at the specified temperatures and durations. Naturally, the lower limits in terms of cooking time and/or temperature should be selected for thinner molded products and vice versa for thicker molded products.

It is advantageous to flour the molded product and/or the blank before further processing. This stabilizes the water balance, on the one hand, prevents the molded products or blanks from sticking to each other, which is already very reduced compared to conventional methods, and promotes the formation of a crust of the desired consistency with heat application without water or steam. The formation of the crust can be influenced or controlled by the type of flouring, in particular the coarseness, distribution and composition of the flour or potato flour.

A further aspect of the invention relates to a molded potato product, which is produced or producible using the method according to the invention in one of the configurations described above.

In a preferred configuration of the invention, the molded potato product according to the invention has a ring-shaped or animal-shaped, heart-shaped, star-shaped etc. basic shape with a maximum thickness or height of 5 cm, in particular 3 cm. The ring-shaped molded potato products, also known as dumpling donuts, preferably have an outer diameter of 7 to 10 cm, in particular 8 cm, an inner diameter of a through-opening having a size from 1.5 to 3 cm.

Alternatively, the molded potato product has the shape of a bowl with a homogeneous or inhomogeneous wall thickness of 1 to 3 cm.

The embodiments described can advantageously be combined with one another, unless explicitly mentioned in individual cases.

The invention is described in more detail below on the basis of examples.

$$Example 1 : Producing a blank from 90 g potato mass and in the shape \\ of a donut ( outer diameter = 8.5 cm / mass cross - section = 2.5 cm )$$

### Production Method for the Deep-Frying Process

The potato mass is produced with the required consistency.

The potato mass is processed under refrigeration.

The potato mass is pressed into a (donut) mold.

The potato mass is removed from the mold.

The pressed blank is placed in a deep fryer.

The oil temperature should be between 150° C. and 160° C.

After reaching a crispy surface and a minimum temperature of 65° C. in the core, the blank (in donut form) is removed from the oil bath (to produce a deep-frozen product after approx. 3 min, depending on the capacity of the deep fryer).

The product is cooled/deep-frozen and packaged.

### Preparation of the Deep-Fried Dumpling Donut in a Deep Fryer

Deep-fry the deep-frozen product at 150 to 175° C. for 3-4 minutes.

### Preparation of the Deep-Fried Dumpling Donut by Baking

Bake the deep-frozen product in the baking oven at 220° C. for 18-20 minutes, depending on the appliance setting.

### Production Method Using a Combi-Steamer or Spiral Stove

The potato mass is produced with the required consistency.

The potato mass is processed under refrigeration.

The potato mass is placed in a (donut) mold in a floured or non-floured state and either left there or removed again.

The blank is placed in a combi-steamer or spiral stove with/without the mold.

With the superheated steam method, the combi-steamer or spiral stove is switched on at 130° C. and approx. 60% steam saturation for 4 min.

Complete gelatinization is achieved at a core temperature of 65° C.

The breading achieves a crispy surface effect similar to deep-frying.

The product is removed from the combi-steamer and removed from the mold after it has cooled down sufficiently to approx. 40° C.

The product can now be packaged in a refrigerated/deep-frozen state.

### Preparation of the Dumpling Donut Produced Using the Hot Steam Method in a Deep Fryer

Deep-fry the deep-frozen product at 175° C. for 3-4 minutes.

### Preparation of the Dumpling Donut Produced Using the Hot Steam Method by Baking

Bake the deep-frozen product at 220° C. for 18-20 minutes, depending on the appliance setting.

After the deep-freeze process, the potato puree (mashed potatoes) can be defrosted while adding a raw potato component in combination with potato flour (starch) under special conditions so that it can be shaped without any particular loss of quality. Here, the raw potato content is required in natural, grated form (2-5 mm) or in a form obtained from an industrially produced potato fiber. This mixture is manually pressed or industrially extruded at a temperature between 4 and 15° C. to produce a shaped blank with a dough diameter of at least 2 to a maximum of 5 cm. The resulting intermediate product is then subjected to a first deep-frying process at 150-160° C. for 2-3 minutes, depending on the shape and dough diameter. The end product can then be deep-frozen or, after a second deep-frying process lasting 3-4 minutes, offered for consumption.

For commercial purposes, the hot steam method (combi-steamer) is advantageous instead of the first deep-frying process. As a guideline, approx. 90 seconds per 1 cm of dough diameter at 130° C. can be adopted to reach the required core temperature of 65° C. for complete gelatinization. However, the shape of the product and the shaping device must be taken into account. For example, double the time is required when using a silicone mold due to the reduced thermal conductivity.

After appropriate cooling (starting at approx. 40° C.), the blank is dimensionally stable and can be stored for the end consumer, breaded or non-breaded, in the refrigerator/freezer. This ensures an extended shelf life for the product.

In the form of a refrigerated/deep-frozen blank, the production method offers aesthetic (variety of shapes), time-saving, energy-saving and health-promoting advantages for the catering business and the private end consumer.

According to the method described above, an end consumer requires a preparation time of approx. 3 minutes at 175° C. in the deep fryer for a 90 g shaped doughnut, for example. A dumpling dish, for example, can then be arranged in the middle of a plate with smoked salmon with horseradish and dill and be ready to serve in a very short time. Previous preparation times are between 18-30 minutes using a prepared, deep-frozen dumpling. Additional time must be allowed in the case of fresh preparation.

Otherwise, the blank can be prepared in a baking oven. For example, a children's dumpling in the shape of a dinosaur (approx. 90 g) can be baked at 200° C. for 15-18 minutes and then served.

It is also worth mentioning that the dumpling or molded potato product according to the invention keeps the food warm for longer time due to its compacted surface.

The desired shape is achieved by adding potato fibers (of natural or industrial origin), which are subjected to an increased pressure force at an appropriate dough temperature. The subsequent deep-frying process forms a stable outer structure by removing water and hardening the starch. Starting at a temperature of 62.3° C., the network structure is activated inside the blank, which is created by the raw potato content of 20-50%. This means that starch grains contained swell up, burst and liquefy. This causes the potato fibers to gelatinize, resulting in a dimensionally stable internal structure. A loss of water during the production process (weight loss of approx. 10%) supports the solidification of the blank.

The dough does not need to be processed in a cooled state with the hot steam method. The cooking time of a blank made from the dough naturally depends on the shape and thickness of the blank. It can be cooked with or without a mold (metal, silicone).

The temperature during steaming is between 120 and 150° C. with 60% to 80% water saturation. Steaming continues until a product core temperature of at least 65° C. is reached. The water loss of the product is 2% by weight due to the added steam.

Thus, the gelatinized blank is prevented from drying out and hardening.

Water loss with resulting solidification occurs with this method during the subsequent cooling process (weight loss approx. 6%).

Cooling takes place at a temperature of approx. −40° C. for 15 minutes in a shock freezer. This achieves a core temperature of +1° C. and an external temperature (surface temperature) of −1° C. of the blank. The product is then packaged. The product adapts to the desired transport and storage temperature of approx. 4 to 7° C. in the packaging.

A dumpling heart with 90 g, a thickness of 3.5 cm and an outer diameter of 6 cm is pressed through a drum molding machine or mold plate machine, then heated in a spiral stove or combi-steamer at 125° C. with 65% steam content for 8 minutes to a core temperature of approx. 80 degrees. A weight loss of 2% is determined. The product is then cooled at approx. −40° C. in a shock freezer until it reaches an internal temperature of +1° C. and an external temperature of −1° C. Subsequently, the product is packaged.

1. A method for producing a molded potato product, comprising the following steps in the indicated order
a) providing a raw potato mass comprising all parts of raw, peeled and chopped potatoes and/or of a technically prepared equivalent selected from the group consisting of: potato flour, starch flour, potato fibers, and dried potato puree,
b) providing a potato mass comprising cooked, peeled and chopped potatoes and/or of a technically prepared equivalent selected from the group consisting of: potato flour, starch flour, potato fibers, and dried potato puree,
c) blending the two masses to form a mixture,
d) cooling the mixture to a temperature of 4-15° C.,
e) shaping a molded product from the cooled mixture,
f) thermally treating the molded product by a hot steam method to reach a core temperature of at least 65° C. in the molded product whereby gelatinizing of potato starch components in the molded product is achieved so that a water content in the molded product decreases during the thermal treatment and a blank results.

2. The method according to claim 1, wherein the thermal treatment in step f) is carried out by means of a combi-steamer or spiral stove.

3. The method according to claim 1, wherein the potato raw mass has a proportion in the range from 10 to 75%, preferably in the range from 10 to 55% and in particular in the range from 20 to 50% of the mixture.

4. The method according to claim 1, further comprising a step g) in which the blank is treated by heat application, in particular by means of deep-frying, baking, toasting or in a hot water bath, to provide a ready-to-eat product.

5. The method according to claim 4, wherein the heat application takes place for a duration of 3 to 10 min.

6. The method according to claim 1, wherein the molded product has a thickness in the range from 1 to 5 cm.

7. The method according to claim 1, wherein the deep-frying in step g) is carried out at a temperature in the range from 140 to 170° C., in particular in the range from 150 to 160° C. and/or for a period of time in the range from 1.5 to 4 min, in particular 2 to 3 min.

8. The method according to claim 1, wherein the molded product after step e) is floured before further processing.

9. A pre-cooked molded potato product for final cooking, produced or producible by a method according to claim 1.

10. The molded potato product according to claim 9, wherein the molded product has a ring-shaped or animal-shaped basic shape with a maximum height of 5 cm.
